(19) United States
(12) Patent Application Publication
(10) Pub. No.: US 2007/0193458 A1
(43) Pub. Date: Aug. 23, 2007

(54) Impression mold for relief art

(76) Inventor: Tsung-Yi Cheng, Taipei Hsien (TW)

Correspondence Address: Tsung-Yi Cheng, 235 Chung - Ho, Box 8-24, Taipei, TW

(21) Appl. No.: 11/357,854

(22) Filed: Feb. 21, 2006

(51) Int. Cl. B41F 1/00; B41G 7/00

(52) U.S. Cl. 101/287; 101/368

(57) ABSTRACT

An impression mold for relief art, for applying slightly three-dimensional pattern on a piece of paper or a card, comprises at least a mold plate and a pattern piece connected to the mold plate. One surface of the mold plate defines an area of molding, which includes a multitude of retaining holes. The pattern piece has one side provided with a predetermined pattern to be impressed and the opposite side provided with a retaining member, whereby the pattern piece can be quickly removed from the mold plate, and whereby other pattern pieces can be quickly arranged on the mold plate.

### FIELD OF THE INVENTION

The present invention relates to impression molds for relief art, more particularly to an impression mold for relief art in which the pattern is replaceable, thereby reducing printing time and production cost.

### BACKGROUND OF THE INVENTION

To enhance three-dimensional visual effect and add values to printed pattern, relief art is commonly used. The traditional impressed patterns of relief art are realized by an impression mold pressing on a piece of paper, which is categorized into manual impression molds, impression cylindrical molds and metallic impression molds. In manual impression molds, a copper plate having the negative mold corresponding to the pattern to be impressed is placed under a piece of paper. The paper sheet is then pressed by a push rod with a round head, whereby the paper sheet is deformed toward the depressions of the negative mold, therefore producing bulged pattern of relief art on the other side of the paper. This means for producing works of relief art is time-consuming and of high labor cost.

An impression cylindrical mold includes a cylinder whose surface is provided with a predetermined pattern. The impression cylindrical mold, sometimes heated, is rolled against a piece of paper and causes facial deformation over the impressed paper, whereby a pattern of relief art can be produced.

A metallic impression mold comprises a pair of metallic plates or a metallic plate and a plastic plate. A piece of paper is sandwiched by the plates. A pattern of relief art will be produced on the paper via a process of metallic stamping or casting.

All of the above mold types have the disadvantage that the pattern to be impressed is not replaceable. Namely, one mold can print only one pattern. To print another pattern, a new mold has to be made, which is not only expensive but time consuming.

### SUMMARY OF THE INVENTION

The primary objective of the present invention is to provide an impression mold for relief art wherein pattern pieces are removable, and they can be rearranged freely on a mold frame. Therefore, the problems of fixed pattern, high mold cost and multiple molds can be solved. The present invention is indeed a practical way to produce works of relief art.

### BRIEF DESCRIPTION OF THE DRAWINGS

FIG. 1 shows the first pattern pieces attached on the first mold plate in the first preferred embodiment of the present invention.

FIG. 2 shows the second pattern piece being attached on the combination of the first pattern pieces and the first mold plate shown in FIG. 1.

FIG. 3 shows the assembly of the first preferred embodiment of the present invention.

FIG. 4 is a perspective view of the impressing device for the first preferred embodiment of the present invention.

FIG. 5 is a perspective view of the impression mold wherein a paper is sandwiched.

FIG. 6 shows the impression mold of the first preferred embodiment being fed into the impressing device.

FIG. 7 is a side view showing the impression mold of the first preferred embodiment being fed into the impressing device.

FIG. 8 shows a paper sheet with a pattern of relief art produced by the present invention.

FIG. 9 is the second preferred embodiment of the present invention wherein the pattern pieces are attached on the impression mold plate.

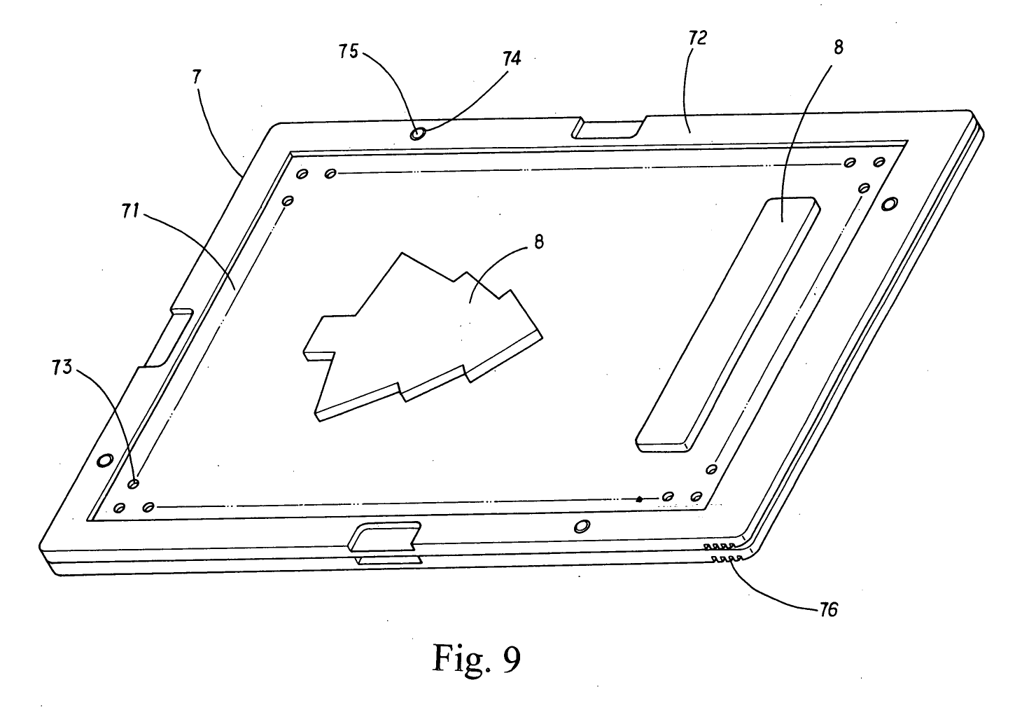

### DETAILED DESCRIPTION OF THE PREFERRED EMBODIMENTS

The various objects and advantages of the present invention will be more readily understood from the following detailed description when read in conjunction with the appended drawings.

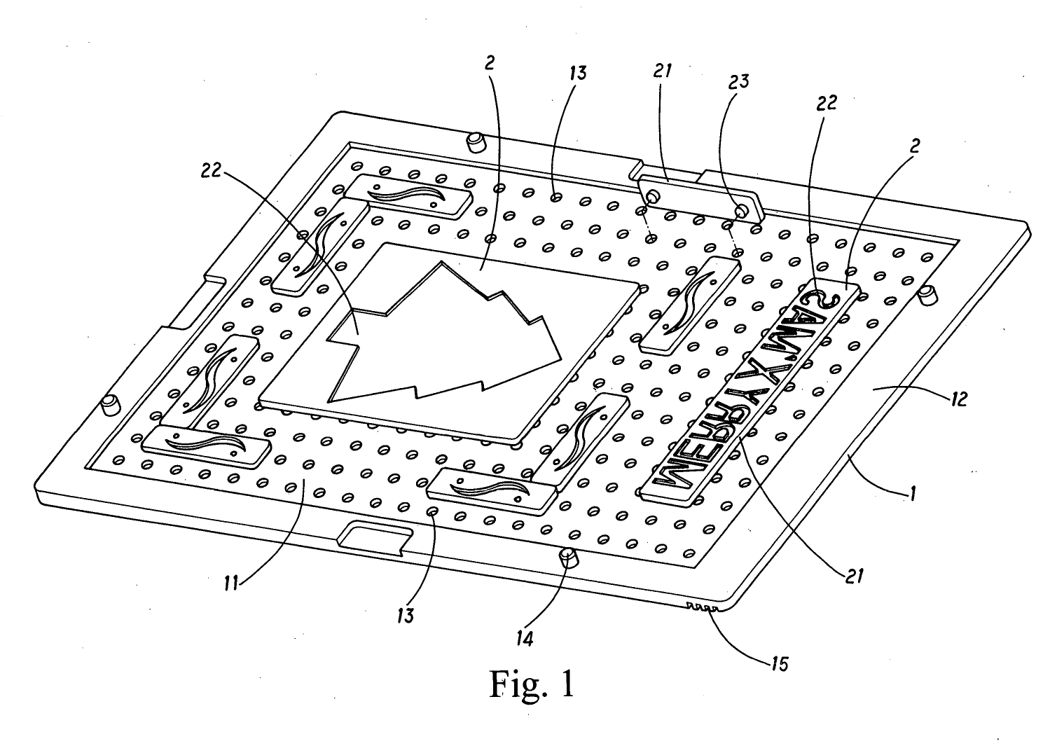

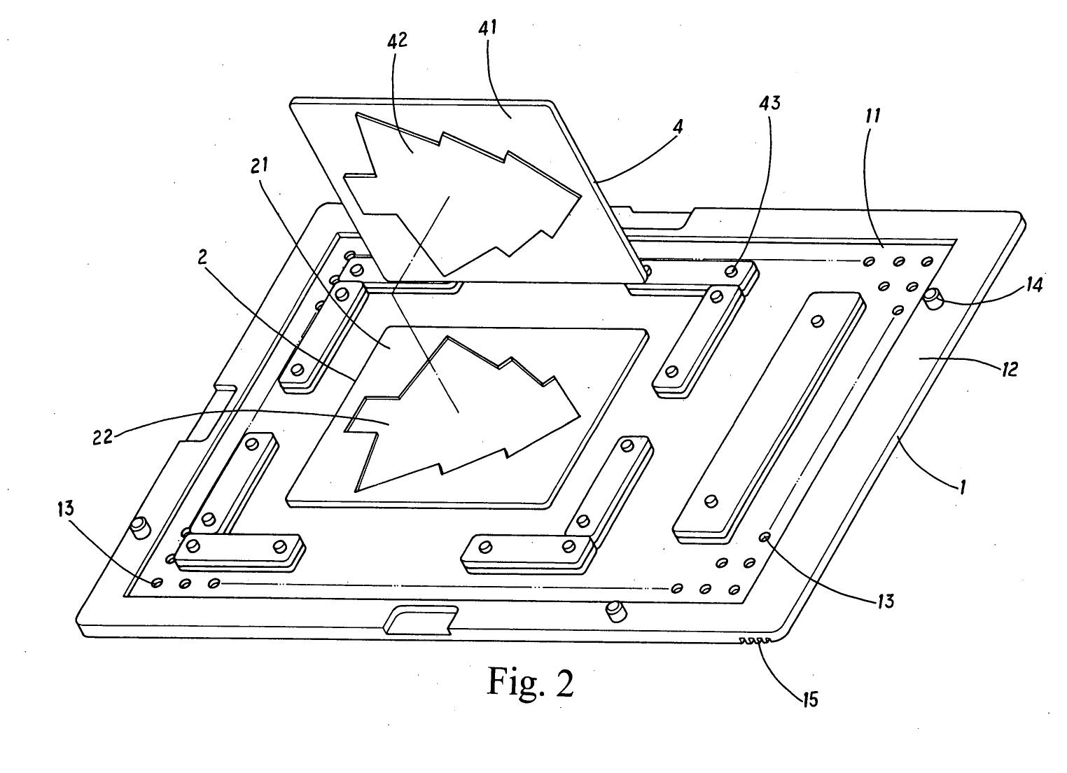

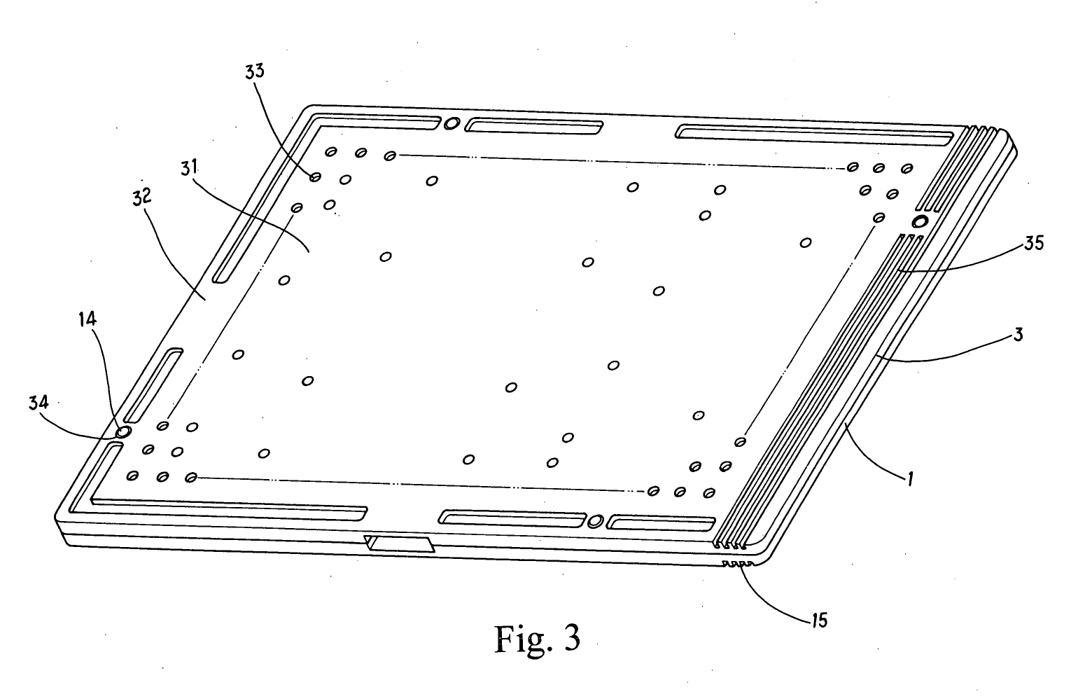

Referring to FIGS. 1, 2 and 3, the first preferred embodiment of the present invention as an impression mold for relief art comprises a first mold plate 1, a multitude of first pattern pieces 2, a second mold plate 3 and a multitude of second pattern pieces 4, thereby forming an impression mold for relief art with replaceable pattern pieces and capable of organizing new patterns. Therefore, it can provide a user with a simple, inexpensive and practical impression mold.

On one side of the first mold plate 1, there a mold frame 12 around the edge of the first mold plate 1, which defines a mold area 11 therein. There is further a set of retaining holes 13 on the mold area 11 and at least a positioning pin 14. At one edge on the opposite side of the first mold plate 1, there is a plurality of antislip strips 15.

Each of the first pattern pieces 2 is a plate main body 21 of predetermined size and shape, whose one side is provided with a predetermined pattern embodied in a depressed pattern portion 22. The opposite side of the plate main body 21 is provided with at least one retaining member 23 corresponding to one of the retaining holes 13 on the first mold plate 1. Thereby, the first pattern pieces 2 are detachable.

One side of the second mold plate 3 is provided with another mold frame 32 and a bulged mold area 31. The second mold plate 3 can be coupled with the first mold plate 1, in which the mold area 31 corresponds to the mold area 11. The mold area 31 is also provided with a set of retaining holes 33, and the mold frame 32 is provided with at least one positioning pin 34 that corresponds to the positioning pin 14 on the first mold plate 1. At one edge on the opposite side of the second mold plate 3, there is a plurality of antislip strips 35.

Each of the second pattern pieces 4 is a plate main body 41 of predetermined size and shape, whose one side is provided with a predetermined pattern embodied in a bulged pattern portion 42. The bulged pattern portion 42 corresponds to the depressed pattern portion 22 on a first pattern piece 2. The opposite side of the plate main body 41 is provided with at least one retaining member 43 corresponding to one of the retaining holes 33 on the second mold plate 3. Thereby, the second pattern pieces 4 are detachable.

Thereby, a user can choose a set of first pattern pieces 2 and their corresponding second pattern pieces 4 to render a pattern on the first mold plate 1 and the second mold plate 3. Thereby, the impression mold assembled can be used to produce the pattern, in the form of relief art, on a piece of paper. Further, since the pattern pieces (2, 4) are detachable, different pattern to be printed can be easily arranged on the impression mold. To finalize the impression, a impressing device 5 is used to process the impression mold, whereby a pattern of relief art on a paper sheet will be formed.

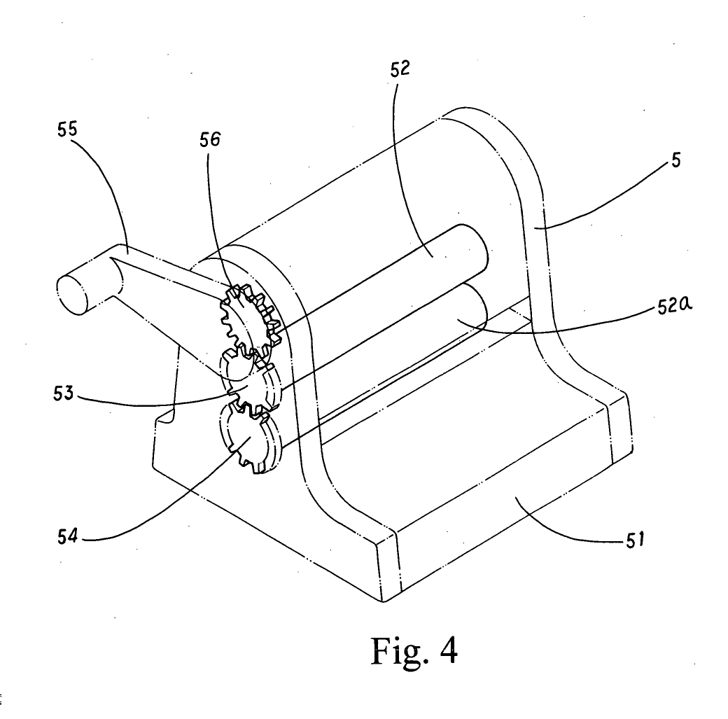

As shown in FIG. 4, the impressing device 5 is preferably a roller device having a machine base 51 and a plurality of rollers 52, 52a. At one end of the roller 52, there are gears 53, 54 that are engaged with the gear 56 within the machine base 51, whereby a handle 55 mounted on the gear 56 will be urged to drive the rollers 52, 52a through the gears. The rollers 52, 52a will impress the mold composed of the first mold plate 1, the second mold plate 3 and the piece of paper therebetween. Since the surfaces of the rollers 52, 52a are made of a soft material such as silicon plastic, the first mold plate 1 and the first pattern pieces 2 will not be damaged by the impression.

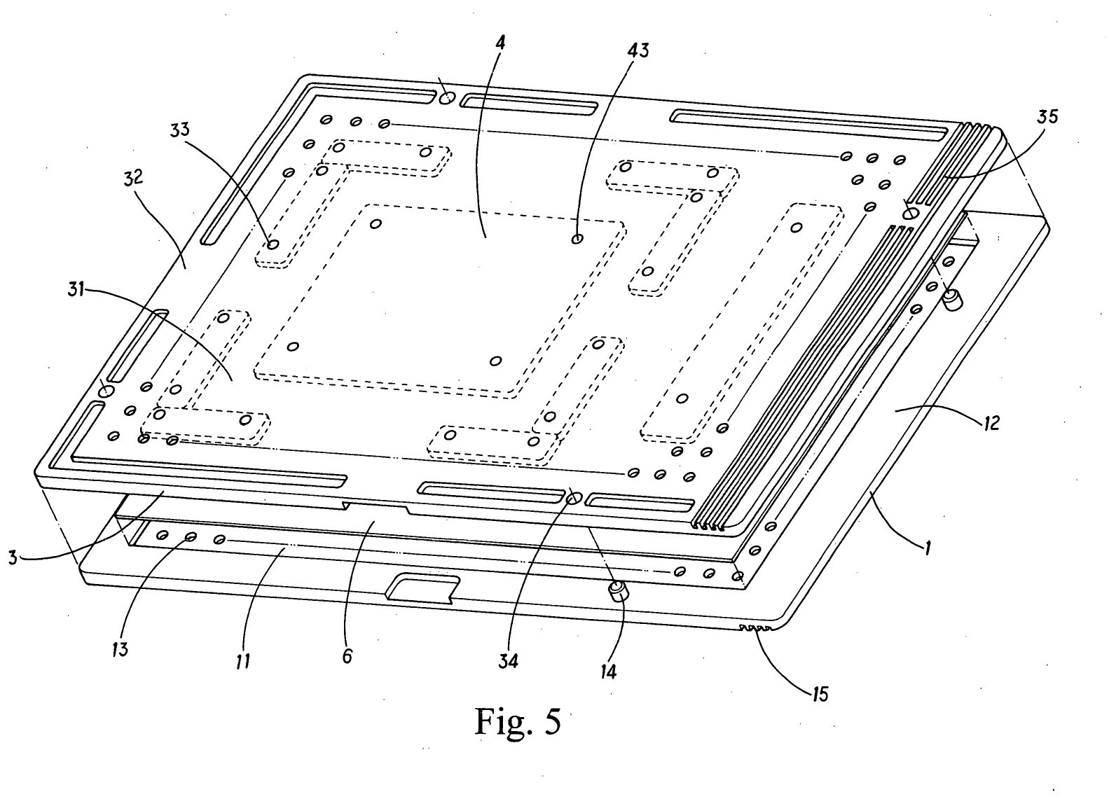

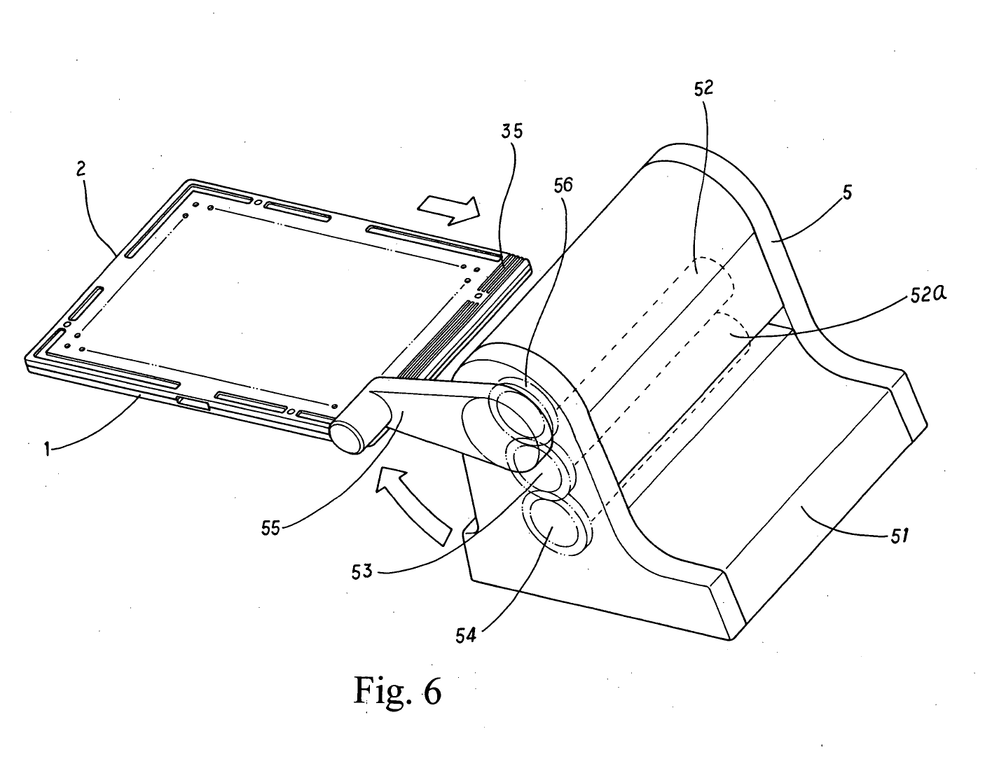

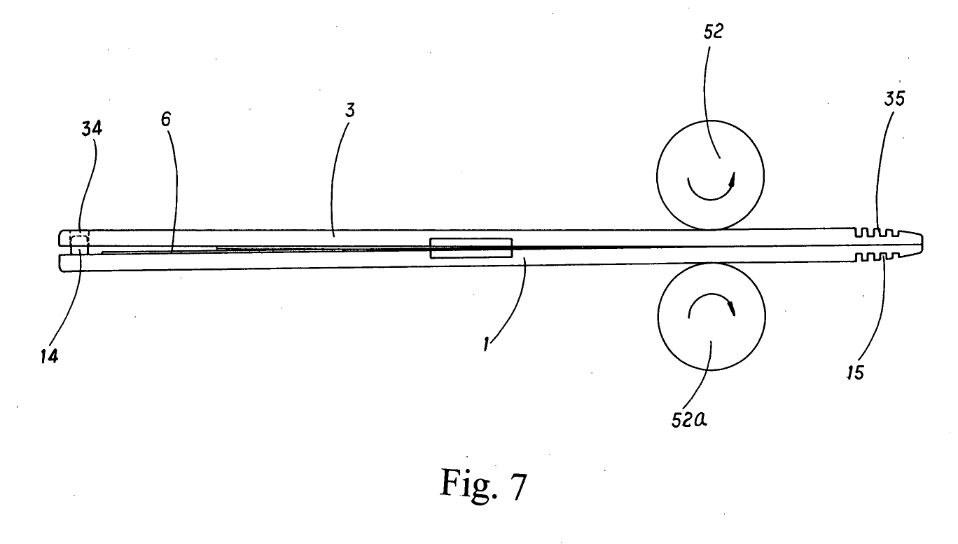

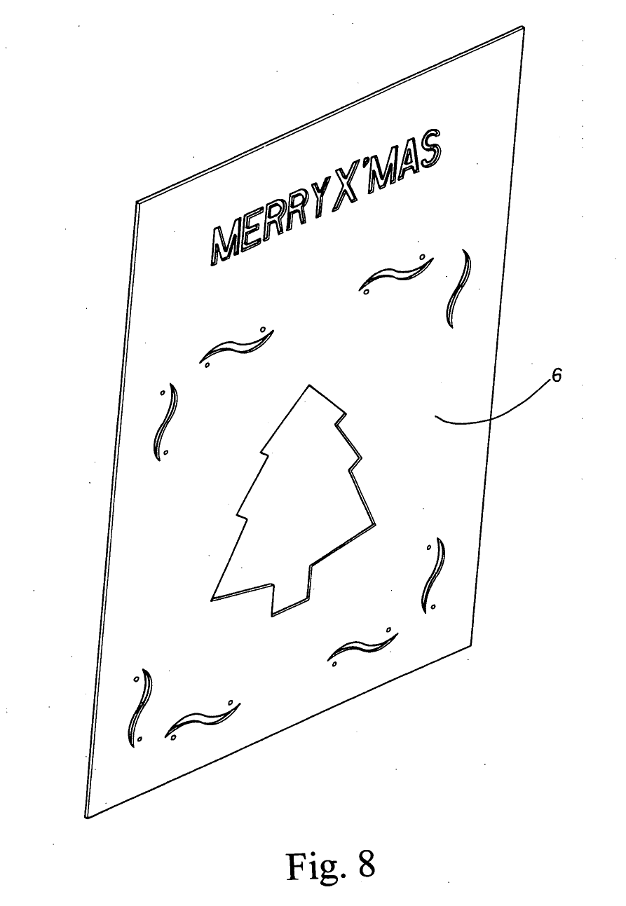

Referring to FIGS. 5 to 8, the process of applying a pattern of relief art on a piece of paper will be illustrated. A first pattern piece 2 and a corresponding second pattern piece 4 are chosen to be respectively attached on the first mold plate 1 and the second mold plate 3 by inserting the retaining members 23, 43 into the retaining holes 13, 23. A piece of paper is place between the first mold plate 1 and the second mold plate 3, sandwiched by the coupled first pattern piece 2 and second pattern piece 4, as shown in FIG. 5. The coupling between the first pattern piece 2 on the first mold plate 1 and the second pattern piece 4 on the second mold plate 3 can be precisely aligned by the engagement between the positioning pins 14 and 44. The combined structure of the first mold plate 1, the second mold plate 3 and the piece of paper 6 therebetween can be smoothly fed into the impressing device 5, between the rollers 52, 52a, with the help of the edge antislip strips 15, 35, as shown in FIG. 6. The assembled mold is guided through the rollers 52, 52a by turning the handle 55 and subsequently the gears 56. This will apply a predetermined pressure on the mold passing through the impressing device 5, as shown in FIG. 7. The first pattern pieces 2 and the corresponding second pattern pieces 4 will produce a pattern of relief art on the piece of paper 6. Further, the first pattern pieces 2 and the second pattern pieces 4 can be removed from the mold when the processing through the impressing device 5 is done.

Since the first mold plate 1 and the second mold plate 3 are all provided with retaining holes 13, 33, a user can conveniently choose first pattern pieces 2 and the corresponding second pattern pieces 4 of different predetermined patterns to produce a variety of patterns of relief art on paper.

Meanwhile, since the first pattern pieces 2 and the second pattern pieces 4 are respectively attached onto the first mold plate 1 and the first pattern pieces 2 through the insertion of the retaining members 23, 43 into the corresponding to the retaining holes 13, 33, the pattern pieces (2, 4) can be easily detached from and rearranged on the mold plates (1, 3) to form various patterns of relief art. This is a substantial improvement from an impression mold of the prior art whose pattern is fixed. Therefore, the present invention can reduce of cost of impression painting.

The removable pattern piece 8 is detachably connected to the mold plate 7. Each of the pattern pieces 8 is a slab body having a surface provided with a predetermined pattern for relief art and an opposite surface with at least one retaining member corresponding to the retaining holes 73, whereby the pattern pieces 8 can be attached onto the mold plate 7. Thereby, the pattern pieces 8 will produce the predetermined pattern on a piece of paper as the mold plate 7 is being guided through an impressing device 5.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An impression mold for relief art, which impresses a predetermined pattern on a piece of paper, comprising:
a first mold plate;
a plurality of first pattern pieces detachably connected to said first mold plate, said first pattern pieces each having a surface provided with said pattern;
a second mold plate; and
a plurality of second pattern pieces detachably connected to said second mold plate, said second pattern pieces each having a surface provided with said pattern;
whereby said first mold plate and said first pattern pieces will be coupled in a way that said first pattern pieces and said second pattern pieces precisely press against each other, and whereby a piece of paper sandwiched between said first pattern pieces and said second pattern pieces will produce said pattern thereon as said coupled mold plates are being guided through an impressing device.

2. The impression mold for relief art of claim 1 wherein said first mold plate further includes a depressed mold area having a plurality of retaining holes and a mold frame surrounding said mold area

3. The impression mold for relief art of claim 2 wherein said mold frame of said first mold plate is further provided with at least a positioning pin.

4. The impression mold for relief art of claim 2 wherein said first mold plate further includes a plurality of antislip strips along one edge thereof.

5. The impression mold for relief art of claim 2 wherein each of said first pattern pieces is a slab body of arbitrary size and shape having a surface provided with a predetermined depressed pattern for relief art and an opposite surface with at least one retaining member corresponding to said retaining holes on said first mold plate, whereby said first pattern pieces can be attached onto said first mold plate.

6. The impression mold for relief art of claim 1 wherein said second mold plate further includes a depressed mold area having a plurality of retaining holes and a mold frame surrounding said mold area.

7. The impression mold for relief art of claim 6 wherein said first mold plate further includes at least a positioning hole for the alignment with said positioning pin on said first mold plate.

8. The impression mold for relief art of claim 6 wherein said second mold plate further includes a plurality of antislip strips along one edge thereof.

9. The impression mold for relief art of claim 1 wherein each of said second pattern pieces is a slab body of arbitrary size and shape having a surface provided with a predetermined bulged pattern for relief art and an opposite surface with at least one retaining member corresponding to said retaining holes on said second mold plate, whereby said second pattern pieces can be attached onto said second mold plate.

10. The impression mold for relief art of claim 1 wherein a pair of said first and said second mold plates and a pair of said first pattern pieces and said second pattern pieces are complementary structures with a male and a female parts.

11. The impression mold for relief art of claim 1 further including a machine base, a plurality of rollers installed within said machine base each having at least an end equipped with a gear and handle attached to one of said gears, whereby said handle will drive the coupled rotation of said rollers through an engaged rotation of said gears.

12. An impression mold for relief art, which impresses a predetermined pattern on a piece of paper, comprising:
at least one mold plate;
a plurality of pattern pieces each having a surface provided with said pattern and an opposite surface provided with at least one retaining member;
whereby said pattern pieces will be detachably connected to said mold plate, and whereby said pattern pieces will produce said pattern on a piece of paper as said mold plate is being guided through an impressing device.

13. The impression mold for relief art of claim 12 wherein said mold plate further includes a depressed mold area having a plurality of retaining holes and a mold frame surrounding said mold area.

14. The impression mold for relief art of claim 13 wherein said mold plate further includes at least a member selected from a positioning pin and a positioning hole.

15. The impression mold for relief art of claim 13 wherein said mold plate further includes a plurality of antislip strips along one edge thereof.

16. The impression mold for relief art of claim 13 wherein each of said pattern pieces is a slab body having a surface provided with a predetermined pattern for relief art and an opposite surface with at least one retaining member corresponding to said retaining holes, whereby said pattern pieces can be attached onto said mold plate.
